(19) United States
(12) Patent Application Publication
(10) Pub. No.: US 2003/0031165 A1
(43) Pub. Date: Feb. 13, 2003

(54) Providing voice over internet protocol networks

(76) Inventor: James D. O'Brien JR., Somerville, MA (US)

Correspondence Address: FISH & RICHARDSON PC, 225 FRANKLIN ST, BOSTON, MA, 02110, US

(21) Appl. No.: 09/928,073

(22) Filed: Aug. 10, 2001

(51) Int. Cl. H04L 12/66

(52) U.S. Cl. 370/352; 370/401

(57) ABSTRACT

Providing Voice Over Internet Protocol (VOIP) networks includes attempting to authorize a call from a user made to a number, routing the call, after the call is authorized, to a remote location, and setting up call signaling at the remote location between the user and a destination of the call so that media content of the call flows between the user and the destination but not through the remote location.

### BACKGROUND

This invention relates to providing Voice over Internet Protocol services.

Devices can communicate multimedia information such as sounds, video, data, and other types of similar information in real time over a network using a protocol such as Session Initiation Protocol (SIP) or H.323 (International Telecommunications Union (ITU) standard approved in 1996, H.323 version two approved in January 1998). The network may be a packet-based network such as an Internet Protocol (IP) network (e.g., an IP telephony network, a Voice Over IP (VOIP) network, or other similar network). SIP and H.323 can each enable functions such as call routing, call signaling, capabilities exchange, media control, and other similar functions. SIP and H.323 are each described further below.

SIP is a signaling protocol that can facilitate initiation, maintenance, and termination of a communication session between SIP user agents, SIP software included in or accessible by a device. A SIP user agent (called a client when sending a request) can send a communication session request to another user agent (called a server when receiving and responding to a request) over an IP network. SIP can enable the client and the server to agree upon characteristics of the communication session, such as service policies, media types, etc.

H.323 defines a set of standards with a variety of protocols that may be used in communicating multimedia information in real time between telephony and IP networks and enabling calls to be routed, controlled, and transported by an IP network. A client and a server may use H.323 standards in initiating, maintaining, and terminating a communication session.

Clients and servers with H.323 capability typically use four main components: terminals, gateways, gatekeepers, and multipoint control units (MCUs). Terminals generally include applications running at the endpoints of the communication session, e.g., at the client(s) and the server(s) involved in a communication session. Gateways generally include mechanisms that enable clients to communicate with non-H.323 devices by translating between different communication services, transmission policies, coding/decoding procedures, and other similar operations. Gatekeepers generally include mechanisms that provide network services such as bandwidth control, call control, address translation, and other similar services to terminals, gateways, and MCUs. MCUs generally include mechanisms that enable multiple terminals to participate in a single communication session.

### SUMMARY

According to an aspect of the present invention, providing Voice Over Internet Protocol (VOIP) networks includes attempting to authorize a call from a user made to a number, routing the call, after the call is authorized, to a remote location, and setting up call signaling at the remote location between the user and a destination of the call so that media content of the call flows between the user and the destination but not through the remote location.

According to another aspect of the present invention, a system includes an authorization mechanism configured to attempt to authorize a call from a user made to a number and a proxy server configured to route the call, after the call is authorized by the authorization mechanism, to a remote server included at a location remote from the authorization mechanism and configured to set up call signaling between the user and a destination of the call so that media content of the call flows between the user and the destination but not through the location.

According to another aspect of the present invention, a system includes an inbound gateway mechanism configured to receive a Voice Over Internet Protocol (VOIP) call made by a user across a network, a gathering mechanism configured to communicate with the inbound gateway mechanism and to gather information related to the VOIP call from the user, an authentication mechanism configured to authenticate the user based at least on the information and on stored information accessible by the authentication mechanism, an outbound gateway mechanism configured to communicate with a destination of the VOIP call, and a server mechanism configured to, once the authentication mechanism authenticates the user, set up call signaling with the inbound gateway mechanism, to set up call signaling with the outbound gateway mechanism, and to instruct the inbound gateway mechanism and the outbound gateway mechanism to stream media content related to the VOIP call to each other.

One or more of the following advantages may be provided by one or more aspects of the invention.

A network service provider can leverage its inbound and outbound VOIP networks to provide telephony services by enabling clients to make calls across a network via a third party. In this way, the network service provider can provide calling card services to its client.

For example, the network service provider can enable its customers to interface to its inbound and outbound VOIP networks to provide calling card services. The network service provider may bundle these calling card services with other services as a convenient package to its customers.

Clients may place a calling card call to one of the customers via the network service provider's inbound VOIP network. The customer may then route the call to its appropriate destination through the outbound VOIP network. The customers may also track calling card usage for accounting or other purposes. In this way, the network service provider's customers need not maintain their own VOIP networks or VOIP network equipment. Rather, the customers may only maintain a mechanism to authenticate calls placed to it via the inbound VOIP network, an IP routing mechanism to route those calls to a destination through the outbound VOIP network, a call signaling and routing mechanism, and any other mechanisms that the customer may use in routing or tracking calls. Such an IP routing mechanism may scale more easily than other calling card telephony network mechanisms. Furthermore, the network service provider may maintain these other mechanisms for a customer, in which case the customer need not maintain any telephony mechanisms or incur the cost of purchasing its own telephony mechanisms. The network services provider may thus be able to bundle telephony services as a package to the customer.

The customers need not rent, lease, or otherwise obtain dedicated circuits to interconnect with telephony providers but may rent, lease, or otherwise obtain a communication link to carry any appropriate messages such as call signaling and authentication messages to the network service provider. Such a communication link typically costs customers less in money and bandwidth because the carried messages are typically much smaller than the media transmitted in the calls themselves, and the network service provider's VOIP networks carry the call media.

Customers who use the network service provider's VOIP networks can gain access to the network service provider's geographic markets without themselves having a presence in those markets. Clients in those geographic markets can locally access the customers via the network service provider's network(s) in their area.

Clients who call a customer via the network service provider's VOIP networks may hear or otherwise receive a message tailored to that particular customer. Each customer can use such personalized messages to brand their service to the clients, the customer's end users.

Other advantages and features will become apparent from the following description and from the claims.

### DESCRIPTION OF DRAWINGS

FIG. 1 shows an exemplary H.323 network configuration.

FIGS. 2A-2B are flowcharts showing examples of call setup processes.

FIG. 3 is a flowchart showing a validation process.

FIG. 4 is an exemplary SIP network configuration.

### DETAILED DESCRIPTION

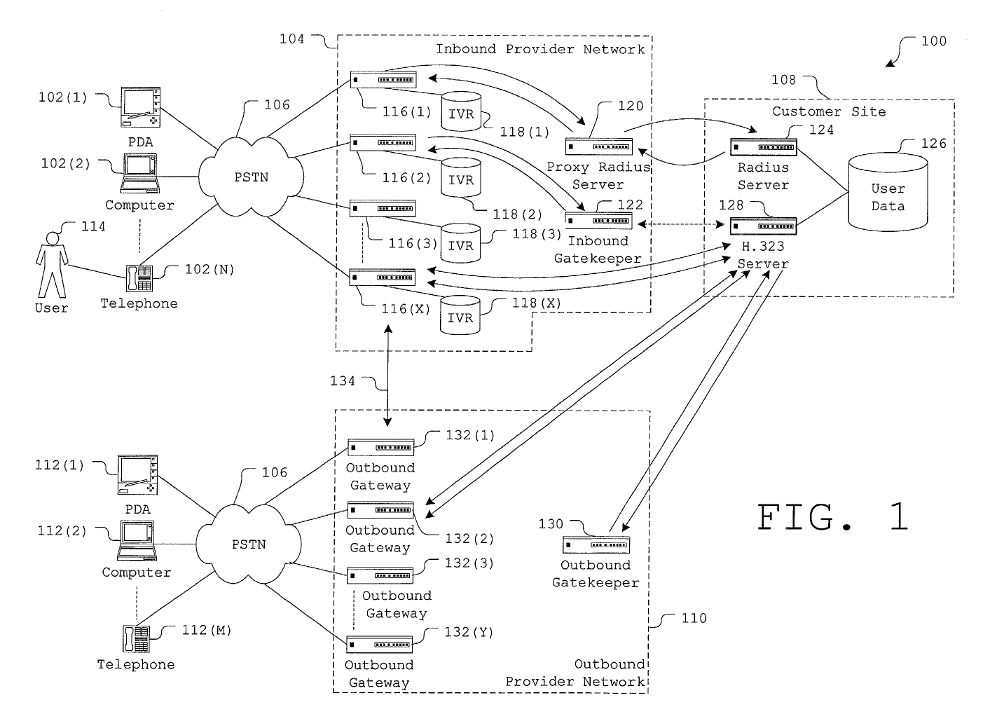

Referring to FIG. 1, an exemplary network 100 includes clients 102(1)-102(N) that can each call an inbound provider network 104 through a public switched telephone network (PSTN) 106 to make VOIP calls through a customer site 108 and an outbound provider network 110 to any of a number of destinations 112(1)-112(M) included on the PSTN 106. (The variable N represents a whole number.) One entity (e.g., a telephone company, a telephone services provider, or other similar entity) typically maintains both the inbound provider network 104 and the outbound provider network 110. In this way, a customer of the entity (e.g., a commercial business, a calling card company, a telemarketing organization, or other similar entity) can maintain the customer site 108 that interfaces with the inbound provider network 104 and the outbound provider network 110 and offer calling services without having to maintain its own VOIP calling infrastructure.

For example, a user 114 can use the client 102(N), hereinafter referred to as telephone 102, to place a call to the destination 112(M), hereinafter referred to as the destination telephone 112. (The variable M represents a whole number.) Note that the VOIP endpoints, the clients 102(1)-102(N) and the destinations 112(1)-112(M), may both receive and transmit VOIP content such as media information to each other.

The user 114 dials in to the inbound provider network 104 via the PSTN 106. The user 114 may use a calling card in calling the inbound provider network 104. The telephone number that the user 114 calls to access the inbound provider network 104 directs the client's call to one of a collection of inbound gateways 116(1)-116(X), hereinafter referred to as the called inbound gateway 116. (The variable X represents a whole number.) Using its associated one of the inbound network provider's interactive voice response (IVR) systems 118(1)-118(X), the called gateway 116 gathers information about the user 114 to pass on to the customer site 108 through a proxy remote authentication dial-in user service (radius) server 120 and/or an inbound gatekeeper 122.

A radius server 124 included in the customer site 108 authenticates the user 114. Authentication generally refers to a process of evaluating a user's permission to access a network or network resources. Authentication may include authenticating that the user 114 is whom the user 114 alleges to be, validating the user 114 based an identifier such as a password, a user name, a digital signature, a digital certificate, or other similar identifier, and performing other similar processes.

The radius server 124 may authenticate the user by comparing the information transmitted from the inbound provider network 104 with information about users registered or otherwise authorized by the customer included in a collection of user data 126. After the customer site 108 authenticates the user 114, an H.323 server 128 included in the customer site 108 can establish H.323 call signaling with an outbound gatekeeper 130 included in the outbound provider network 110. Once the H.323 server 128 and the outbound gatekeeper 130 have established call signaling, the H.323 server 128 can instruct the called inbound gateway 116 to stream media information from the telephone 102 to the appropriate one of a collection of outbound gateways 132(1)-132(Y) included in the outbound provider network 110, hereinafter referred to as the called outbound gateway 132. (The variable Y represents a whole number.) Media may then flow between the telephone 102 and the destination telephone 112 across the PSTN 106 through the called inbound gateway 116 and the called outbound gateway 132.

In this way, the media stream(s) that carries VOIP media information between the clients 102(1)-102(N) and the destinations 112(1)-112(M) can flow on a communication link 134 directly between the inbound gateways 116(1)-116(X) and the outbound gateways 132(1)-132(Y). Thus, the media information stays on the inbound provider network 104 and the outbound provider network 110. In this way, the media information can avoid congestion on the Internet, where VOIP media information typically travels. Furthermore, if the same entity provides both the inbound provider network 104 and the outbound provider network 110, that entity can efficiently manage traffic on the provider networks 104 and 110, thereby better serving its customers and/or the VOIP call endpoints. For instance, the media information may receive a higher Quality of Service (QoS) by traveling on networks provided by one entity. That entity can more easily manage QoS considerations such as delay, packet loss, and jitter than can multiple entities which may or may not help maintain QoS over the Internet.

Additionally, since the customer site 108 can help set up the VOIP call between endpoints but not be involved in the actual transmission of media information between those endpoints, the customer need not provide or otherwise maintain VOIP equipment. The customer site 108 would only need equipment related to the user's call such as for authenticating the user's calling card or other calling mechanism, for billing the user 114 for VOIP calls made using the customer's calling card or other calling mechanism, and for performing other similar tasks.

Alternatively, the network customer may be relieved of the need to maintain any equipment if the network provider provides or otherwise maintains the customer site 108 including the radius server 124, the collection of user data 126, and the H.323 server 128. In such a case, the customer site 108 may be a separate site as shown in the network 100 or be included in the inbound provider network 104 or other network maintained by the network provider. Furthermore, the network customer may not track a VOIP call made using a calling card. Rather, the network provider may gather information related to a user's VOIP call such as length of the VOIP call, geographic location of the VOIP call's endpoints, and other similar information. The network provider may then provide this gathered information to the network customer for tracking, billing, and/or other similar purposes.

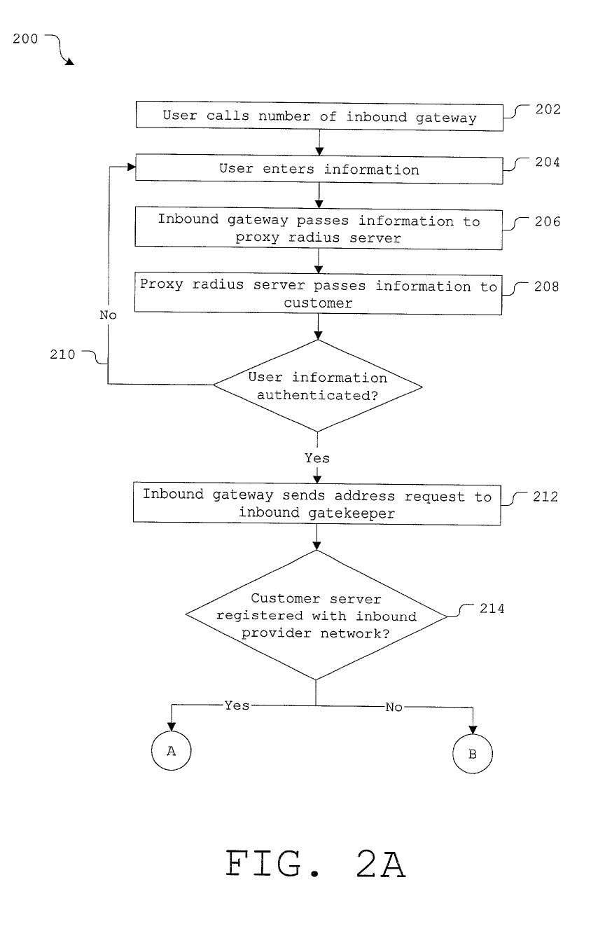

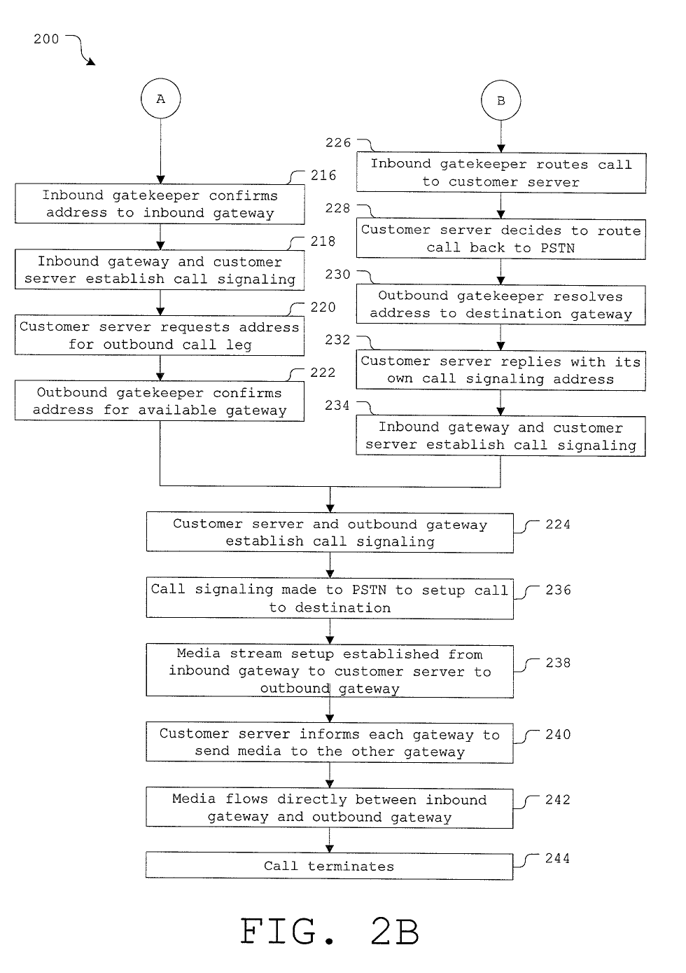

Referring to FIG. 2A, an example calling process 200 is shown. The process 200 is explained below with reference to the elements included in FIG. 1, but the process 200 can be adapted for application or other network systems including the same or different elements.

In the process 200, the user 114 begins a call to the destination telephone 112 by using the telephone 102 to call 202 a direct inward dial (DID) telephone number using a calling card. A calling card generally refers to a mechanism that enables a card user to call a certain telephone number and access a customer calling system. Examples of a calling card include a prepaid calling account, a credit card, a debit card, a to-be-billed calling account, and other similar mechanisms. The customer calling system can provide the card user with telephone and/or network access up to a certain amount of time or money associated with the calling card or can later charge the calling card's account for telephone or network usage.

The DID number that the user 114 calls corresponds to one or more of the inbound gateways 116(1)-116(X). The DID number may correspond to a particular one or to a group of the inbound gateways 116(1)-116(X) based on how many of the inbound gateways 116(1)-116(X) are associated with the provider of the calling card, e.g., a calling card company, that is a customer of the network provider. If the DID number is associated with more than one of the inbound gateways 116(1)-116(X), then the telephone 102 may interface with one of the inbound gateways 116(1)-116(X) based on an allocation procedure, e.g., a load balancing algorithm, a round robin technique, or other allocation as determined or assigned by the customer. In this example, the DID number accesses the called inbound gateway 116 and its associated IVR 118.

The user 114 typically does not know which of the inbound gateway(s) 116(1)-116(X) is associated with the DID number. Furthermore, the user 114 may not know that the DID number dials in to the inbound provider network 104. From the user's perspective, the DID number enables the user 114 to reach the calling card company.

When the call from the telephone 102 arrives at the called inbound gateway 116, the IVR 118 responds to the call. The IVR 118 responds to the call by running an IVR script on the called gateway 116. The IVR script generally includes one or more automatically executed commands. In this example, the IVR 118 plays a welcome message and asks the user 114 to input identification information. The identification information may include the user's calling card code, a calling card expiration date, a user identification code, a destination telephone number, and/or other types of similar information.

The user 114 enters 204 the requested information using the telephone 102. The IVR 118 may accept the requested information through a voice-response system, a touch-tone telephone system, or other similar system.

After collecting the requested information, the IVR 118 (or the called inbound gateway 116) passes 206 that information to the proxy radius server 120 for authentication. The proxy radius server 120 passes 208 the user information to the radius server 124 at the appropriate customer site 108. The proxy radius server 120 may pass the information by creating an enhanced service provider (ESP) call or other similar type of call to the customer site 108.

The radius server 124 verifies the user information against stored user information included in the collection of user data 126. The radius server 124 informs the proxy radius server 120 whether the user information was authenticated or not. The proxy radius server 120 passes these results to the called inbound gateway 116.

If the radius server 124 does not authenticate the user information, then the IVR 118 may prompt 210 the user 114 to reenter the requested information. After a certain number of failed authorization attempts, however, the IVR 118 may signal the called inbound gateway 116 to terminate its connection with the telephone 102.

If the radius server 124 authenticates the user information, e.g., verifies the validity of the calling card or the user's identification code, then the inbound provider network 104 attempts to resolve the IP address of the H.323 server 128 included in the customer site 108. If the IVR 118 did not previously request the destination telephone number from the user 114, the IVR 114 may request that information from the user 114 after user authentication but before the called inbound gateway 116 attempts to resolve the address of an endpoint at the customer site 108. The endpoint may include an H.323 endpoint having access to the collection of user data 126 such as the H.323 server 128.

In attempting to resolve the H.323 server's address, the called inbound gateway 116 sends 212 a registration, admission, and status (RAS) address request (ARQ) signal to the inbound gatekeeper 122. The inbound gatekeeper 122 uses RAS to translate the alias or local address of the H.323 server 128 into an IP address. The called inbound gateway 116, the inbound gatekeeper 122 and the H.323 server 128 may, however, communicate as appropriate using a protocol other than RAS. The inbound gatekeeper 122 typically performs address translation with RAS using a table associating aliases and local addresses with IP addresses. The inbound gatekeeper 122 can also perform other RAS-enabled functions such as bandwidth control and zone admissions authorization.

Before proceeding to resolve the H.323 server's address, the inbound gatekeeper 122 determines 214 if the H.323 server 128 is registered with the inbound provider network 104. Registering the H.323 server 128 with the inbound provider network 104 may involve the customer site 108 registering the H.323 server's IP address with the inbound network provider 104 at some time before the inbound gatekeeper 122 attempts to resolve the H.323 server's address.

Referring to FIG. 2B, if the H.323 server 128 is registered with the inbound provider network 104, then the inbound gatekeeper 122 confirms 216 the address and availability of the H.323 server 128 to the called inbound gateway 116. The inbound gatekeeper 122 may confirm the H.323 server's address by sending an address confirmation (ACF) signal or other similar signal to the called inbound gateway 116.

Knowing the H.323 server's address, the called inbound gateway 116 can establish 218 call signaling with the H.323 server 128. Such call setup may use a protocol such as the H.225 standard (ITU H.225.0 standard recommended in November 2000).

With a first call signaling leg set up between the inbound provider network 104 via the called inbound gateway 116 and the customer site 108 via the H.323 server 128, the H.323 server 128 attempts to establish a second call signaling leg between the customer site 108 and the outbound provider network 110. The H.323 server 128 may attempt to set up 220 the second call signaling leg by requesting 220 the address of the outbound call leg included in the outbound provider network 110. For example, the H.323 server 128 may send an ARQ signal to the outbound gatekeeper 130. The outbound gatekeeper 130 can confirm 222 its address to the H.323 server 128 by sending an ACF signal to the H.323 server 128. By sending the ACF signal, the outbound gatekeeper 130 can also confirm the availability of the called outbound gateway 132.

Once the H.323 server 128 confirms the address of the called outbound gateway, the H.323 server 128 can establish 224 call signaling with the called outbound gateway 132 using a protocol such as H.225. How the process 200 continues is described below. First, how the process 200 proceeds to resolve the address of the H.323 server 128 and the called outbound gateway 132 is described for when the H.323 server 128 is not registered with the inbound provider network 104.

If the H.323 server 128 is not registered with the inbound provider network 104, then the inbound gatekeeper 128 routes 226 the call to the customer site 108. Rather than forwarding the ARQ signal sent by the called inbound gateway 116, the inbound gatekeeper 122 may send a location request (LRQ) signal to the H.323 server 128.

The H.323 server 128 can decide 228 to route the call back to the PSTN 106. The H.323 server 128 may thus send an LRQ signal (possibly the same or slightly modified LRQ signal sent by the inbound gatekeeper 122) to the outbound gatekeeper 130. The outbound gatekeeper 130 can respond to the LRQ signal by resolving 230 the address of the called outbound gateway 132 with a location confirmation (LCF) signal sent to the H.323 server 128. The LCF signal can include contact information for the called outbound gateway 132 and/or for the outbound gatekeeper 130. If for some reason the outbound gatekeeper cannot locate an available one of the outbound gateways 132(1)-132(Y), then the outbound gatekeeper 130 may return a location reject (LRJ) signal to the H.323 server 128 indicating that the call's endpoint is not registered with the outbound gatekeeper 130 or is otherwise unavailable.

Now knowing address information for the call's endpoint, the H.323 server 128 can reply 232 to the LRQ signal from the inbound gatekeeper 122 with an LCF signal confirming its own address to the inbound provider network 104. The inbound gatekeeper 122 receives the LCF signal and sends an ACF signal to the called inbound gateway 116 confirming the H.323 server's address.

Knowing the H.323 server's address, the called inbound gateway 116 can establish 234 call signaling with the H.323 server 128 using a protocol such as H.225. Once the H.323 server 128 confirms the address of the called outbound gateway, the H.323 server 128 can establish 224 call signaling with the called outbound gateway 132 using a protocol such as H.225.

Returning to how the process 200 continues after the customer site 108 and the outbound provider network 110 establish call signaling whether the H.323 server 128 is registered with the inbound provider network 104 or not, the called outbound gateway 132 makes 236 call signaling to the PSTN 106 to set up the VOIP call to the destination telephone 112.

With call signaling established to the destination telephone 112, a media stream setup can be established 238 from the called inbound gateway 116 to the H.323 server 128 to the called outbound gateway 132. The media stream setup may be established between the called inbound gateway 116 and the H.323 server 128 and between the H.323 server 128 and the called outbound gateway 132 using the H.245 standard (ITU H.245 standard recommended in February 2000) or other similar protocol. The H.323 server 128 may also use the H.245 protocol or other similar protocol for call control operations such as setup, teardown, redirection, and other similar operations.

With the media stream setup established, the H.323 server 128 informs 240 the called inbound gateway 116 and the called outbound gateway 132 to send media information to the other called gateway 116 or 132. The called inbound gateway 116 and the called outbound gateway 132 may then stream 242 media information between each other using the communication link 134. The called inbound gateway 116 and the called outbound gateway 132 may stream media information using a real-time transport protocol (RTP), a real-time transport control protocol (RTCP), a real-time streaming protocol (RTSP), or other similar protocol. Real-time protocols generally refer to Internet protocols for communicating real-time data such as multimedia information over the Internet.

The media stream flows until the VOIP call terminates 244. Once a connection exists between the VOIP call's endpoints, either endpoint may end the call. A user at either endpoint may end the call simply by hanging up. The H.323 server 128 may terminate the call at any point during the call, with or without a request from an endpoint, as the H.323 server 128 maintains control of the call throughout the duration of the call. The H.323 server 128 may decide to terminate a call, for example, if the prepaid calling card that the user 114 used to place the call runs out of time or money.

The user 114 need not use a calling card to place a call to the destination telephone 112. Rather, the user 114 may call a DID number to determine the validity of a particular telephone number (or other type of information) as indicated by the collection of user data 126. For example, the collection of user data 126 can include a do-not-call telemarketing list. The user 114 can call the DID number, enter in a particular telephone number, and based whether the collection of user data 126 indicates the particular telephone number as a do-not-call telephone number, a VOIP call may be set up between the telephone 102 and the destination telephone 112, the endpoint associated with the particular telephone number.

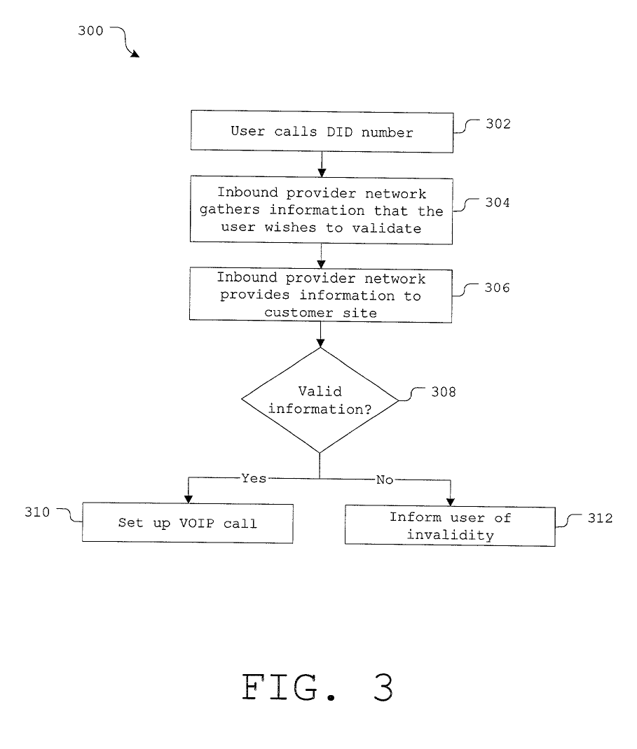

Referring to FIG. 3, in an example validation process 300, the user 114 may call the DID number to determine if a do-not-call telemarketing list includes the particular telephone number. The user 114 calls 302 a DID number, using or not using a calling card. The DID number corresponds to one of the inbound gateways 116(1)-116(X), the called gateway 116. When the user 114 calls the DID number and accesses the inbound network provider 104 and one of the inbound gateways 116(1)-116(X) as described above with reference to FIG. 2, the IVR 118 associated with the called inbound gateway 116 may run and gather 304 information related to the user 114 and/or to the particular information that the user 114 wishes to validate. For example, the IVR 118 may prompt the user 114 to enter a telephone number on the keypad of the telephone 102. The inbound provider network 104 can pass 406 the gathered information to the customer site 108 for validation.

The radius server 124 included in the customer site 124 determines the validity of the gathered information. The radius server 124 can compare the gathered information with information included in the collection of user data 126. If the collection of user data 126 includes the gathered information, then the radius server 124 may presume that the gathered information is valid, e.g., the gathered information is not included in a do-not-call list. Conversely, the radius server 124 may presume the invalidity of the gathered information if the gathered information is included in the collection of user data 126, depending on the organization of the collection of user data 126. The radius server 126 passes the results of the validity check to the inbound provider network 104.

If the gathered information is valid, then the elements included in the network 100 can setup 310 a VOIP call between the telephone 102 and the destination telephone 112 (which is associated with the gathered information) similar to the setup described above with reference to FIG. 2. If the gathered information is not valid, then the inbound provider network 104 informs the user 114 of the gathered information's invalidity. The IVR 118 may automatically provide the user 114 with an invalidation message if the customer site 108 informs the inbound provider network 104 that the gathered information is invalid. The user 114 may have the option to re-try the validation of the gathered information or to enter in new information for validation.

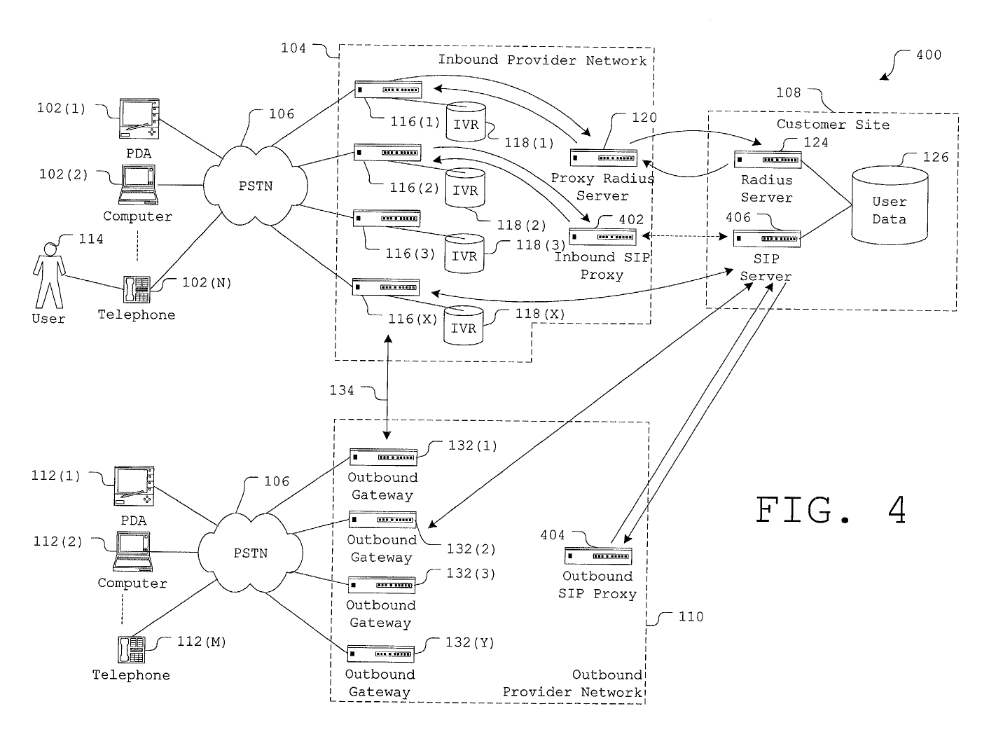

Referring to FIG. 4, an exemplary SIP network 400 illustrates a network configuration in which a VOIP call between the telephone 102 and the destination telephone 112 can be set up using SIP. Some of the elements included in the SIP network 400 are shown as elements described above with reference to the network 100 of FIG. 1. These elements may function as and be identical to those described above and/or may be slightly modified to accommodate SIP.

Other elements included in the SIP network 400 vary from those in the network 100 but perform similar functions. Rather than including gatekeepers (e.g., the inbound gatekeeper 122 and the outbound gatekeeper 130 of FIG. 1), the SIP network 400 includes SIP proxy servers. The inbound provider network 104 includes an inbound SIP proxy server 402 that employs SIP but functions similar to the inbound gatekeeper 122. Likewise, the outbound provider network 110 includes an outbound SIP proxy server 404 that employs SIP but functions similar to the outbound gatekeeper 130. Additionally, the customer site 108 is equipped to handle SIP. Instead of using the H.323 server 128, the customer site 108 in the SIP network 400 includes a SIP server 406 that functions similar to the H.323 server 128.

The elements shown and described with reference to FIGS. 1, 2, 3, and 4 can be implemented in a variety of ways.

Information communicated between endpoints of a VOIP call can include data, instructions, or a combination of the two. The information may be in packets. Each sent packet may be part of a packet stream, where each of the packets included in the packet stream fits together to form a timewise contiguous stream of data. Information may be communicated between endpoints via multicast, unicast, or some combination of both. Examples of types of information that may be communicated between the endpoints using H.323, SIP, or other protocol include media information such as audio (including voice signals), video, data, and other similar information. Such protocols may communicate any combination of such information types at any given time. Examples of endpoint applications that may use an H.323, SIP, or alternate protocol infrastructure include audio streaming, video streaming, Internet telephony, videoconferencing, collaborative computing, conference calling, distance learning, support and help desk applications, interactive shopping applications, and other similar applications.

Exemplary networks are shown configured for H.323 (FIG. 1) and for SIP (FIG. 4), but these or other networks can use these or other similar protocols to setup and control VOIP calls.

The exemplary network 100 and the SIP network 400 each show PDAs, mobile computers, and stationary telephones as endpoints for VOIP calls, but the endpoints may include any kind of devices configured to utilize VOIP. Examples of such devices include mobile telephones, stationary computers, servers, pagers, and other types of similar devices. Additionally, the endpoints for VOIP calls may be remotely located from each other, e.g., be included in a separate network, be at a different geographic location, and so on. Furthermore, VOIP calls may occur between different types of devices. Any number of potential endpoints may communicate with the PSTN 106. In other words, the variables N and M may each equal the same or different whole number, one or higher.

The customer site 108 in the exemplary network 100 and in the SIP network 400 may be provided by an application service provider (ASP). An ASP hosts applications on its own servers within its own facilities. Customers of the ASP (e.g., the user 114) may access the applications via private lines or a public network such as the Internet.

The gatekeepers 122 and 130 in the exemplary network 100 can each include devoted gatekeeper devices, servers with gatekeeping functionality, or other similar devices.

The gateways 116(1)-116(X) and 132(1)-132(Y) in the exemplary network 100 and in the SIP network 400 can each include any device or mechanism capable of communicating with their associated inbound or outbound gatekeeper 122 or 130 or inbound or outbound SIP proxy 402 or 404. Examples of the gateways 116(1)-116(X) and 132(1)-132(Y) include devoted gateway devices, computers, proxy servers, virtual private network gateways, Realm Specific Internet Protocol (RSIP) gateways, or other similar devices.

The H.323 server 128 in the exemplary network 100 can include any device capable of using H.323 such as an application server, a file server, a mobile computer, a stationary computer, or other similar device. The SIP server 406 in the SIP network 400 can include any device capable of using SIP such as an application server, a file server, a mobile computer, a stationary computer, or other similar device. The H.323 server 128 and the SIP server 406 may, depending on network setup, be capable of performing call signaling, call routing, application services, and/or accounting services.

The inbound SIP proxy 402 and the outbound SIP proxy 404 in the SIP network 400 can each include any device capable of communicating with SIP such as a devoted proxy server, a file server, a mobile computer, a stationary computer, or other similar device.

The radius server 124 and the proxy radius server 120 in the exemplary network 100 and in the SIP network 400 can include any device capable of performing authentication tasks such as a devoted proxy server, an application server, a file server, a mobile computer, a stationary computer, or other similar device. Although authentication functions are shown in the exemplary network 100 and in the SIP network 400 using the radius protocol, other authentication procedures may be used such as a challenge/response method or other similar procedure.

The PSTN 106 in the exemplary network 100 and in the SIP network 400 can include any network capable of supporting a call between two endpoints such as the public switched telephone network and other similar networks.

The IVRs 118(1)-118(X) in the exemplary network 100 and in the SIP network 400 can each include any mechanism capable of communicating with its respective gateway and gathering information from a user. The IVRs 118(1)-118(X) may be voice activated and/or electronically activated such as with touch-tone telephone technology.

The collection of user data 126 in the exemplary network 100 and in the SIP network 400 can include a storage mechanism such as a data queue, a buffer, a local or remote memory device, or other similar mechanism. The information may be organized in the collection of user data 126 as a database or as databases.

Elements included in the exemplary network 100 and in the SIP network 400 can communicate with other element(s) included in their respective network over one or more communication links. These communication links can include any kind and any combination of communication links such as modem links, Ethernet links, cables, point-to-point links, infrared connections, fiber optic links, wireless links, cellular links, Bluetooth, satellite links, and other similar links. Communications may travel over the communication links using transmission control protocol (TCP), TCP/IP, user datagram protocol (UDP), UDP/IP, and/or other similar protocols.

Furthermore, the exemplary network 100 and the SIP network 400 are each simplified for ease of explanation. The networks 100 and 400 may include more or fewer additional elements such as networks, communication links, proxies, firewalls or other security mechanisms, Internet Service Providers (ISPs), MCUs, gatekeepers, gateways, and other elements.

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

What is claimed is:

1. A method comprising:
attempting to authorize a call from a user made to a number;
routing the call, after the call is authorized, to a remote location; and
setting up call signaling at the remote location between the user and a destination of the call so that media content of the call flows between the user and the destination but not through the remote location.

2. The method of claim 1 further comprising collecting information related to the user to be used in authorizing the user.

3. The method of claim 1 further comprising verifying the validity of the destination.

4. The method of claim 1 further comprising tracking usage of a calling card used by the user to make the call.

5. The method of claim 1 further comprising streaming the media content from the user and to the destination after the call signaling is set up.

6. The method of claim 1 in which the call signaling uses an H.323 routing protocol.

7. The method of claim 1 in which the call signaling uses a session initiation protocol.

8. An article comprising a machine-readable medium which contains machine-executable instructions, the instructions causing a machine to:
attempt to authorize a call from a user made to a number;
route the call, after the call is authorized, to a remote location; and
set up call signaling at the remote location between the user and a destination of the call so that media content of the call flows between the user and the destination but not through the remote location.

9. The article of claim 8 further causing a machine to collect information related to the user to be used in authorizing the user.

10. The article of claim 8 further causing a machine to verify the validity of the destination.

11. The article of claim 8 further causing a machine to track usage of a calling card used by the user to make the call.

12. The article of claim 8 further causing a machine to stream the media content from the user and to the destination after the call signaling is set up.

13. The article of claim 8 in which the call signaling uses an H.323 routing protocol.

14. The article of claim 8 in which the call signaling uses a session initiation protocol.

15. A system comprising:
an authorization mechanism configured to attempt to authorize a call from a user made to a number; and
a proxy server configured to route the call, after the call is authorized by the authorization mechanism, to a remote server included at a location remote from the authorization mechanism and configured to set up call signaling between the user and a destination of the call so that media content of the call flows between the user and the destination but not through the location.

16. The system of claim 15 further comprising an inbound mechanism configured to receive the call and to communicate with the authorization mechanism.

17. The system of claim 15 further comprising an Interactive Voice Response (IVR) mechanism configured to collect information related to the user to be used in authorizing the user.

18. The system of claim 15 further comprising a plurality of Voice Over Internet Protocol (VOIP) mechanisms, each of the plurality of VOIP mechanisms configured to receive a call made to a different number.

19. The system of claim 15 in which the remote server is also configured to verify the validity of the destination.

20. The system of claim 15 in which the remote server is also configured to track usage of a calling card used by the user to make the call.

21. The system of claim 15 further comprising a gateway mechanism configured to stream the media content from the user and to the destination after the remote server sets up the call signaling.

22. The system of claim 15 in which the proxy server sets up the call signaling using an H.323 routing protocol.

23. The system of claim 15 in which the proxy server sets up the call signaling using a session initiation protocol.

24. The system of claim 15 in which the user makes the call using a calling card.

25. A system comprising:
an inbound gateway mechanism configured to receive a Voice Over Internet Protocol (VOIP) call made by a user across a network;
a gathering mechanism configured to communicate with the inbound gateway mechanism and to gather information related to the VOIP call from the user;
an authentication mechanism configured to authenticate the user based at least on the information and on stored information accessible by the authentication mechanism;
an outbound gateway mechanism configured to communicate with a destination of the VOIP call; and
a server mechanism configured to, once the authentication mechanism authenticates the user, set up call signaling with the inbound gateway mechanism, to set up call signaling with the outbound gateway mechanism, and to instruct the inbound gateway mechanism and the outbound gateway mechanism to stream media content related to the VOIP call to each other.

26. The system of claim 25 further comprising
an inbound network including the inbound gateway mechanism and the gathering mechanism, and
an outbound network at a remote location from the inbound network and including the outbound gateway mechanism.

27. The system of claim 26 in which the inbound network also includes the authentication mechanism.

28. The system of claim 26 further comprising a customer network at a location remote from the inbound network and the outbound network and including the authentication mechanism.

29. The system of claim 25 further comprising an inbound proxy mechanism located between the inbound gateway mechanism and the server mechanism and configured to communicate with the inbound gateway mechanism and with the server mechanism.

30. The system of claim 25 further comprising an outbound proxy mechanism located between the outbound gateway mechanism and the server mechanism and configured to communicate with the outbound gateway mechanism and with the server mechanism.

31. The system of claim 25 in which the gathering mechanism includes an interactive voice response mechanism.

32. The system of claim 25 in which the authentication mechanism includes a radius server.

33. The system of claim 25 in which the server mechanism is also configured to maintain control of the VOIP call while the inbound gateway mechanism and the outbound gateway mechanism stream the media content to each other.

34. The system of claim 25 in which the server mechanism includes an H.323 server.

35. The system of claim 25 in which the server mechanism includes a SIP server.

36. The system of claim 25 in which the user makes the VOIP call using a calling card and the information gathered by the gathering mechanism includes an identifier associated with the calling card.

37. The system of claim 25 in which the information includes a telephone number and the stored information includes an indication of telephone numbers that the user may not call.
